(19) United States
(12) Patent Application Publication
(10) Pub. No.: US 2015/0302686 A1
(43) Pub. Date: Oct. 22, 2015

(54) WAGERING GAME WITH THREE-DIMENSIONAL TILTED ARRAY PROVIDING ENHANCED FUNCTIONALITY

(71) Applicant: WMS Gaming, Inc., Waukegan, IL (US)

(72) Inventors: Joel R. Jaffe, Glenview, IL (US); Andrew J. Saia, Chicago, IL (US)

(21) Appl. No.: 14/690,133

(22) Filed: Apr. 17, 2015

Related U.S. Application Data
(60) Provisional application No. 61/981,600, filed on Apr. 18, 2014.

(51) Int. Cl. G07F 17/32; G07F 17/34

(52) U.S. Cl. CPC G07F 17/3213; G07F 17/34

(57) ABSTRACT

Gaming systems and methods include game-logic circuitry having central processing units and memory devices storing instructions that, when executed, cause the game-logic circuitry to receive an input, display an array and a graphical representation of a plurality of symbol-bearing reels within a field of view of a player, and award an award based on a generated game outcome. The symbol-bearing reels include a plurality of first symbols and a plurality of second symbols. In some embodiments, the first symbols are volumetric symbols and the second symbols are planar. In some embodiments, the first symbols and second symbols are volumetric symbols. Each symbol-bearing reel includes a surface defining a geometric plane with the volumetric symbols extending away from the surface while planar symbols lie on the geometric plane. Volumetric symbols near the array can be visible to the player while the planar symbols are not. Volumetric symbols can obscure adjacent symbols.

### CROSS-REFERENCE TO RELATED APPLICATIONS

This application claims the benefit of U.S. Provisional Application No. 61/981,600, filed Apr. 18, 2014.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to creating player anticipation of certain symbols in and near the array through visual enhancement of those symbols.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to one aspect of the present invention, a gaming system comprises one or more input devices, one or more display devices, and game-logic circuitry. The game logic circuitry comprises one or more central processing units and one or more memory devices. The one or more memory devices store instructions that, when executed by the one or more central processing units, cause the game-logic circuitry to receive an input indicative of a wager, display an array and a graphical representation of a plurality of symbol-bearing reels within a field of view of a player, and award an award based on a generated game outcome. The input indicative of the wager is received via at least one of the one or more input devices. Each of the symbol-bearing reels includes a surface defining a geometric plane. The plurality of symbol-bearing reels includes a plurality of planar symbols lying on the geometric plane and a plurality of first volumetric symbols having a first virtual height. The first virtual height extends a first distance away from the surface such that the first volumetric symbols obscure a view of at least a first portion an adjacent planar symbol. The first volumetric symbols satisfy a predetermined criterion that is not satisfied by the planar symbols. The award is determined based on symbols disposed within the array for the generated game outcome. The generated game outcome is responsive to receiving the input indicative of the wager.

According to another aspect of the invention, a computer-implemented method in a gaming system includes receiving an input indicative of a wager, displaying a graphical representation of a plurality of symbol-bearing reels and an array within a field of view of a player, generating a game outcome, and awarding an award. The gaming system has game-logic circuitry including one or more central processing units and one or more memory devices. The input indicative of a wager is received via at least one of one or more input devices. The graphical representation of the plurality of symbol-bearing reels and the array are displayed on at least one of one or more display devices. Each of the symbol-bearing reels includes a surface defining a geometric plane. The plurality of symbol-bearing reels includes a plurality of planar symbols lying on the geometric plane and a plurality of first volumetric symbols having a first virtual height. The first virtual height extends a first distance away from the surface such that the first volumetric symbols obscure a view of at least a first portion an adjacent planar symbol. The first volumetric symbols also satisfy a predetermined criterion that is not satisfied by the planar symbols. The game outcome is generated by the game-logic circuitry and is responsive to receiving the input indicative of the wager. The award is awarded by the game logic circuitry and is based on symbols disposed within the array for the generated game outcome.

According to another aspect of the invention, a computer-implemented method in a gaming system comprises receiving an input indicative of a wager, displaying an array and a graphical representation of a plurality of symbol-bearing reels within a field of view of a player, generating a game outcome responsive to receiving the input indicative of the wager, and awarding an award based on symbols disposed within the array for the generated game outcome. The input indicative of the wager is received via at least one of one or more input devices, an input indicative of a wager. The displayed array includes at least a portion of the symbol-bearing reels. The plurality of symbol-bearing reels includes a plurality of first symbols and a plurality of second symbols. Each of the symbol-bearing reels includes a surface defining a geometric plane. The first symbols are volumetric symbols extending a distance away from the surface. The second symbols are planar symbols lying on the geometric plane. The game outcome is generated by the game-logic circuitry. The award is awarded by the game-logic circuitry. The generated game outcome includes an animated representation of spinning the symbol-bearing reels. During the spinning, at least one of the first symbols is visible within the field of view prior to entering the array.

According to another aspect of the invention, a gaming system includes a gaming machine, a random element generator, and game-logic circuitry. The gaming machine is primarily dedicated to playing at least one casino wagering game. The gaming machine includes a gaming cabinet, an electronic display device, and an electronic input device. The cabinet is constructed to house components associated with the casino wagering game. The electronic display device and the electronic input device are coupled to the gaming cabinet. The electronic input device is configured to receive a physical input from a player to initiate the casino wagering game and transform the input into an electronic data signal. The random element generator is configured to generate one or more random elements. The game-logic circuitry is configured to initiate the casino wagering game, display on the electronic display device a graphical representation of a plurality of symbol-bearing reels and an array within a field of view of a player, determine an outcome of the casino wagering game, direct the electronic display device of the gaming machine to display the outcome, and award an award in response to the outcome meeting a predetermined award criterion. The casino wagering game is initiated in response to the electronic data signal from the electronic input device of the gaming machine. Each of the symbol-bearing reels includes a surface defining a geometric plane. The plurality of symbol-bearing reels includes a plurality of planar symbols and a plurality of first volumetric symbols. Each of the plurality of planar symbols and each of the plurality of first volumetric symbols are disposed at a respective position on the symbol-bearing reels. The plurality of planar symbols lie on the geometric plane. The plurality of first volumetric symbols have a first virtual height extending a first distance away from the surface such that the first volumetric symbols obscure a view of at least a first portion an adjacent planar symbol. The first volumetric symbols satisfy a predetermined criterion that is not satisfied by the planar symbols. The determined outcome of the casino wagering game is based, at least in part, on the one or more random elements. The displayed outcome uses the graphical representation of the plurality of symbol-bearing reels. The predetermined award criterion including evaluation of symbols on the symbol-bearing reels that are disposed within the array.

According to another aspect of the invention, a method of operating a gaming system includes generating one or more random elements with the random element generator, receiving a wager input to initiate the casino wagering game, displaying on the electronic display device a graphical representation of a plurality of symbol-bearing reels and an array within a field of view of a player, determining an outcome of the casino wagering game, displaying the outcome on the electronic display device of the gaming machine, and awarding an award in response to the outcome meeting a predetermined award criterion. The gaming system includes a random element generator, game-logic circuitry, and a gaming machine. The gaming machine is primarily dedicated to playing at least one casino wagering game. The gaming machine includes a gaming cabinet, an electronic display device, and an electronic input device. The cabinet is constructed to house components associated with the casino wagering game. The electronic display device and the electronic input device are coupled to the gaming cabinet. The wager is received responsive to a physical input to the electronic input device of the gaming machine. Each of the symbol-bearing reels includes a surface defining a geometric plane. The plurality of symbol-bearing reels includes a plurality of planar symbols and a plurality of first volumetric symbols. Each of the plurality of planar symbols and each of the plurality of first volumetric symbols are disposed at a respective position on the symbol-bearing reels. The planar symbols lie on the geometric plane. The first volumetric symbols have a first virtual height extending a first distance away from the surface such that the first volumetric symbols obscure a view of at least a first portion an adjacent planar symbol. The first volumetric symbols satisfy a predetermined criterion that is not satisfied by the planar symbols. The outcome is determined by the game-logic circuitry and is based, at least in part, on the one or more random elements. The outcome is displayed on the electronic display device of the gaming machine using the graphical representation of the plurality of symbol-bearing reels. The award is awarded using the game-logic circuitry. The predetermined award criterion includes evaluation of symbols on the symbol-bearing reels that are disposed within the array.

According to another aspect of the invention, a gaming system includes a gaming machine, a random element generator, and game-logic circuitry. The gaming machine is primarily dedicated to playing at least one casino wagering game. The gaming machine includes a gaming cabinet, an electronic display device, and an electronic input device. The cabinet is constructed to house components associated with the casino wagering game. The electronic display device and the electronic input device are coupled to the gaming cabinet. The electronic input device is configured to receive a physical input from a player to initiate the casino wagering game and transform the input into an electronic data signal. The random element generator is configured to generate one or more random elements. The game-logic circuitry is configured initiate the casino wagering game, display on the electronic display device a graphical representation of a plurality of symbol-bearing reels and an array within a field of view of a player, determine an outcome of the casino wagering game, direct the electronic display device of the gaming machine to display the outcome using the graphical representation of the plurality of symbol-bearing reels, and award an award in response to the outcome meeting a predetermined award criterion. The casino wagering game is initiated in response to the electronic data signal from the electronic input device of the gaming machine. Each of the symbol-bearing reels includes a surface defining a geometric plane. The plurality of symbol-bearing reels includes a plurality of first symbols and a plurality of second symbols. Each of the plurality of first symbols and each of the plurality of second symbols are disposed at a respective position on the symbol-bearing reels. Each of the symbol-bearing reels includes a surface defining a geometric plane. The plurality of first symbols are volumetric symbols extending a distance away from the surface. The plurality of second symbols are planar symbols lying on the geometric plane. The determined outcome is based, at least in part, on the one or more random elements. The display of the outcome includes an animated representation of spinning the symbol-bearing reels. At least one of the first symbols is visible within the field of view prior to entering the array while the respective position of the at least one first symbol on the symbol-bearing reel is not visible within the field of view. The predetermined award criterion includes evaluation of symbols on the symbol-bearing reels that are disposed within the array.

According to yet another aspect of the invention, computer readable storage media is encoded with instructions for directing a gaming system to perform the above methods.

According to still another aspect of the invention, the above gaming system is incorporated into a single, free-standing gaming terminal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 is an image of an exemplary wagering-game screen of a wagering game displayed on a gaming terminal, wherein some reels are stopped and a reel or reels are in motion, depicting at least some aspects of an embodiment according to the present concepts.

FIG. 5A is an image of the wagering game represented in FIG. 4 following completion of the depicted wagering game.

FIG. 5B is an image of the wagering game represented in FIG. 4 following completion of the depicted wagering game during evaluation of the depicted wagering game outcome.

FIG. 6 is a flowchart for an algorithm that corresponds to instructions executed by a controller in accord with at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

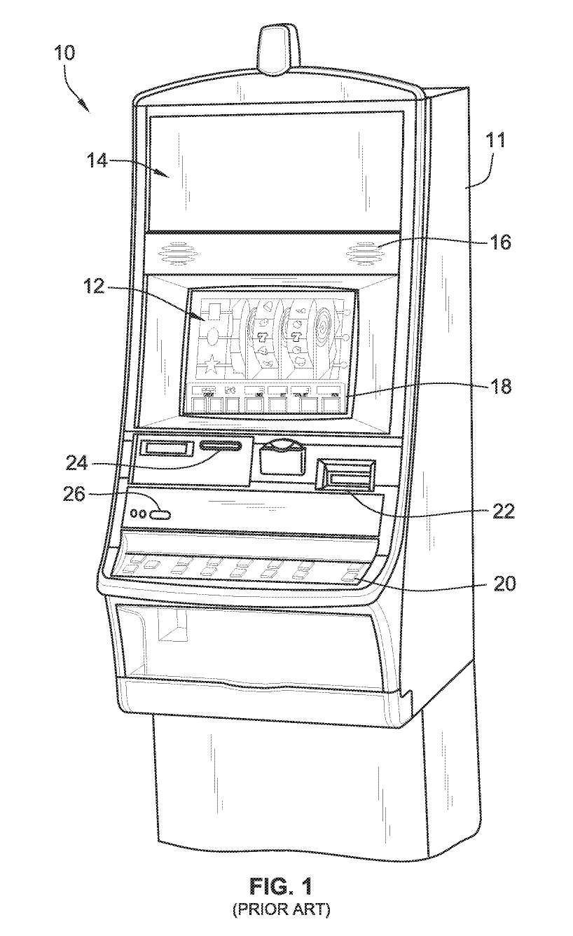

Referring to FIG. 1, there is shown a gaming machine 10 similar to those used in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. No. 6,517,433 and Patent Application Publication Nos. US2010/0069160 and US2010/0234099, which are incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

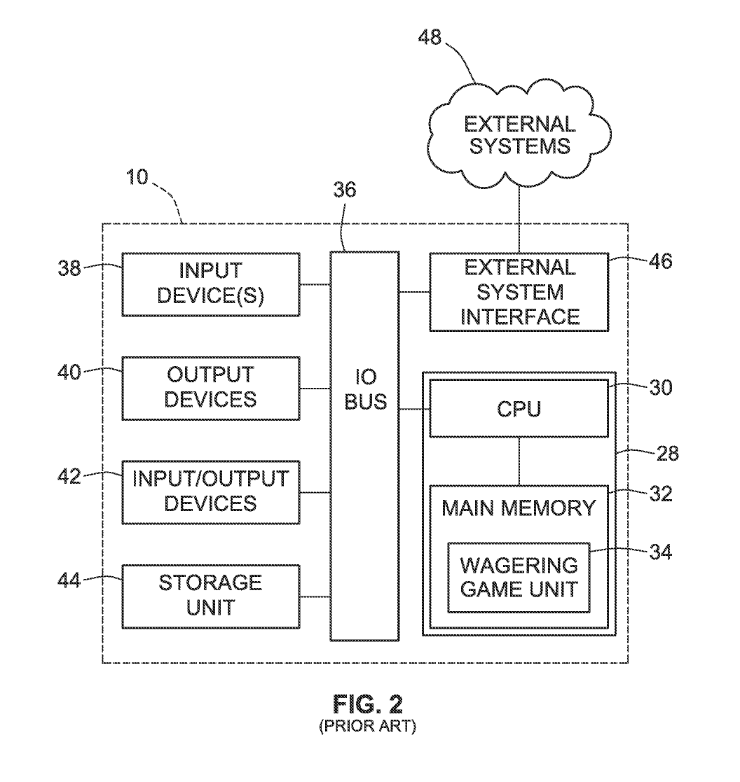

Turning now to FIG. 2, there is shown a block diagram of the gaming-machine architecture. The gaming machine 10 includes game-logic circuitry 28 having a central processing unit (CPU) 30 connected to a main memory 32. The CPU 30 may include any suitable processor(s), such as those made by Intel and AMD. By way of example, the CPU 30 may include a plurality of microprocessors including a master processor, a slave processor, and a secondary or parallel processor. Game-logic circuitry 28, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 28, and more specifically the CPU 30, comprises one or more controllers or processors and such one or more controllers or processors need not be disposed proximal to one another and may be located in different devices or in different locations. The game-logic circuitry 28, and more specifically the main memory 32, comprises one or more memory devices which need not be disposed proximal to one another and may be located in different devices or in different locations. The game-logic circuitry 28 is operable to execute all of the various gaming methods and other processes disclosed herein. The main memory 32 includes a wagering-game unit 34. In one embodiment, the wagering-game unit 34 may cause wagering games to be presented, such as video poker, video black jack, video slots, video lottery, etc., in whole or part.

The game-logic circuitry 28 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to a storage unit 44 and an external-system interface 46, which may be connected to external system(s) 48 (e.g., wagering-game networks).

The external system 48 includes, in various aspects, a gaming network, other gaming machines or terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external-system interface 46 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 48 such that the gaming machine 10 operates as a thin, thick, or intermediate client. The game-logic circuitry 28—whether located within (“thick client”), external to (“thin client”), or distributed both within and external to (“intermediate client”) the gaming machine 10—is utilized to provide a wagering game on the gaming machine 10. In general, the main memory 32 (comprising one or more memory devices) stores programming for an RNG, game-outcome logic, and game assets (e.g., art, sound, etc.). When a wagering-game instance is executed, the CPU 30 (comprising one or more processors or controllers) executes the RNG programming to generate one or more pseudo-random numbers. The pseudo-random numbers are utilized by the CPU 30 when executing the game-outcome logic to determine a resultant outcome for that instance of the wagering game. The resultant outcome is then presented to a player of the gaming machine 10 by accessing the associated game assets, required for the resultant outcome, from the main memory 32. The CPU 30 causes the game assets to be presented to the player as outputs from the gaming machine 10 (e.g., audio and video presentations).

The gaming machine 10 may include additional peripheral devices or more than one of each component shown in FIG. 2. Any component of the gaming-machine architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

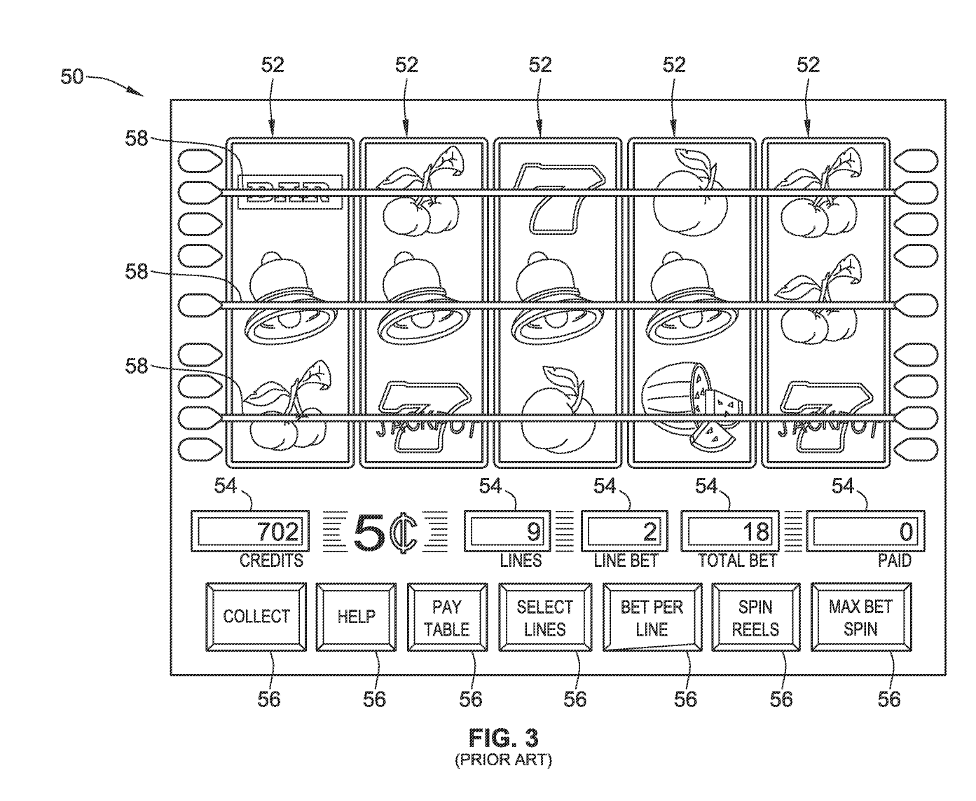

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The game-logic circuitry 28 operates to execute a wagering-game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 12 or secondary display 14) through the display of information such as, but not limited to, text, graphics, static images, moving images, etc., or any combination thereof. In accord with the method of conducting the wagering game, the game-logic circuitry 28 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 28 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 30 causes the recording of a digital representation of the wager in one or more storage media (e.g., storage unit 44), the CPU 30, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU 30 (e.g., the wager in the present example). As another example, the CPU 30 further, in accord with the execution of the stored instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 28 to determine the outcome of the wagering-game instance. In at least some aspects, the game-logic circuitry is configured to determine an outcome of the wagering-game instance at least partially in response to the random parameter.

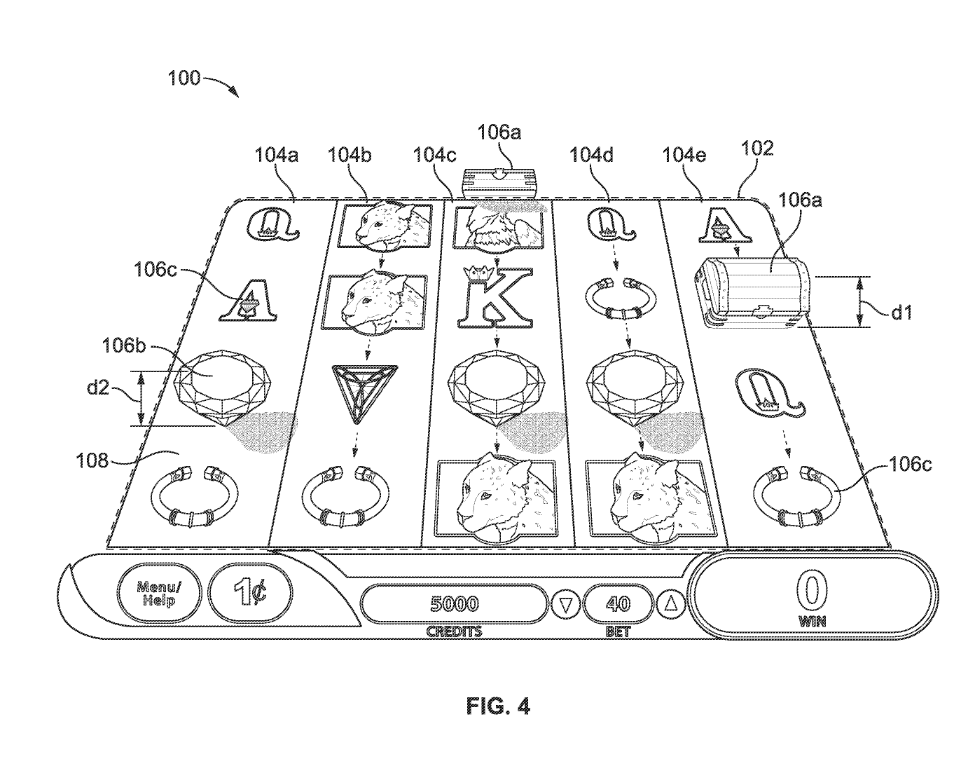

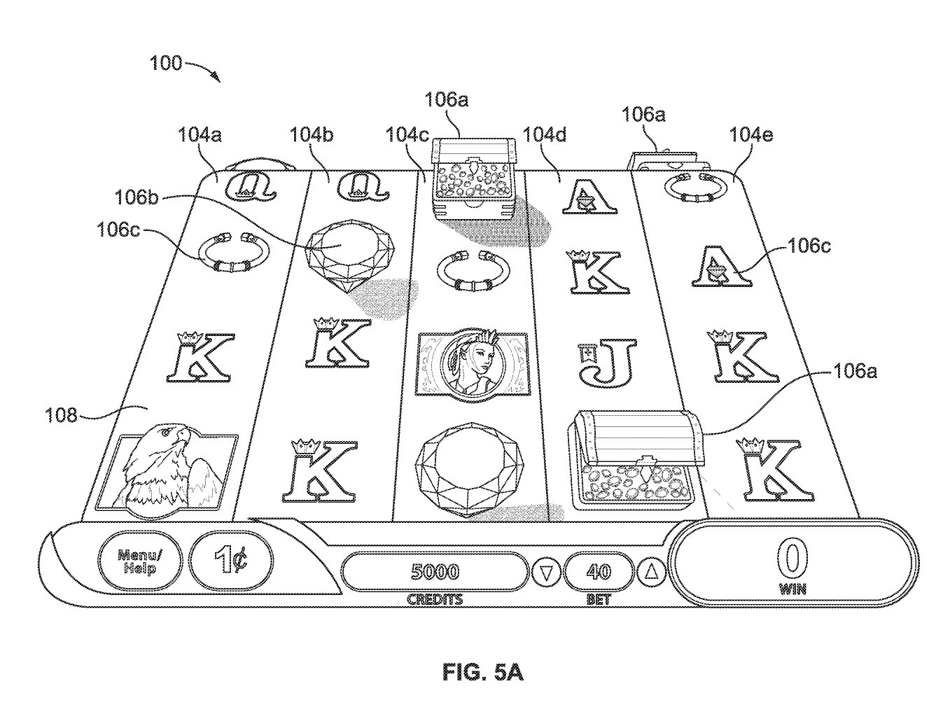

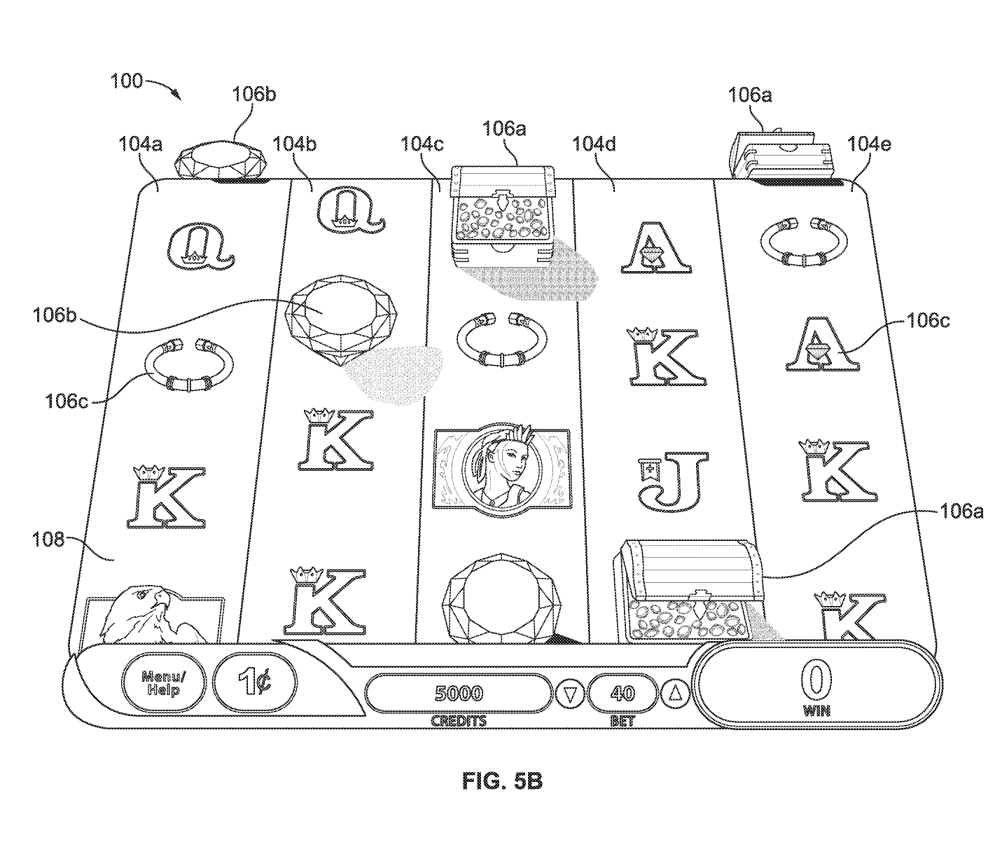

Turning now to FIGS. 4-5B, an example of a wagering game including symbols having different virtual heights is shown. Embodiments of the present disclosure allow for increased player excitement during play of the wagering game by creating a sense of anticipation due to a visual enhancement of certain symbols in the symbol array, as they are about to enter the symbol array, while they pass through the symbol array, and after exiting the symbol array. The visual enhancement can include “upgrading” some, but not all, symbols that are rendered to be displayed as flat (e.g., having a length and width dimension only) on a video display to a three-dimensional rendering in which such symbols also appear to have a virtual height dimension in space. In other words, these visually enhanced symbols appear to extend away from a planar surface that otherwise confines the non-enhanced symbols. Due to the virtual height of the visually enhanced symbols, as they enter a field of view of the player, the tops of these symbols can appear on a horizon in the field of view before any of the flat or non-enhanced symbols, thus creating a sense of anticipation in the player as he or she eagerly awaits to see what kind of symbol is appearing in the field of view, what is the reason for its enhancement (e.g., a higher value compared to non-enhanced symbols), and whether such enhanced symbol will be part of an award when the outcome of the wagering game is revealed. These visually enhanced symbols can satisfy a criterion, such as having a value that is higher than or enhanced compared to a corresponding value of non-enhanced symbols. Further, in some embodiments, when the enhanced symbols are in the field of view, the height of the visually enhanced symbols obscures the view of lesser-valued symbols within the array—thus garnering more of the player's attention for these symbols. These and other examples are described below in connection with the illustrations.

The wagering-game screen 100 includes an array 102 and a plurality of symbol-bearing reels 104a-e within the field of view of a player. The wagering-game screen 100 simulates the window that is presented to the player of a mechanical slots game in which only a portion of the mechanical reels is visible to the player through the window. Thus, the “field of view” of the player includes parts of the symbol-bearing reels 104a-e that are visible to the player and presented on the video display during the wagering game. The array 102 includes at least a portion of the symbol-bearing reels 104a-e therein. As discussed above, symbols within the array 102 are used to represent the outcome of the wagering game and an award is awarded based on one or more combinations of symbols appearing in the array. In some embodiments, the displayed portion of the symbol-bearing reels 104a-e extends beyond the array 102. This simulates a mechanical slots game in which the player can see parts of the reels outside the window that bend away from the player, but these peripherally visible parts are not evaluated as part of the wagering game outcome. In some embodiments, the array 102 extends beyond the displayed portion of the symbol-bearing reels 104a-e. It should be noted that the discussion herein refers to symbols, reels, and the like as if they were tangible things, but in embodiments in which the wagering game is displayed on a video display, such discussion refers to computer renderings of these tangible things.

Each of the symbol-bearing reels 104a-e includes multiple symbols 106a-c disposed at respective positions thereon. In the illustrated embodiment, the symbols 106a-c includes first volumetric symbols 106a, second volumetric symbols 106b, and planar symbols 106c. A “volumetric” symbol is distinguished from a “planar” symbol herein in that a planar symbol extends along or follows only two dimensions (e.g., X and Y) of a surface defining a geometric plane (note the surface can be flat or curved or twisted a la a Mobius strip), whereas a volumetric symbol occupies a three-dimensional space (e.g., X, Y, and Z) relative to the surface and thus extends not only along two dimensions (e.g., X and Y) of the surface but also a distance away (e.g., Z) from the surface. The planar symbols 106c can lie on the geometric plane or slightly above or below it, but have only planar (e.g., length and width) dimensions and no virtual height dimension or visual thickness. It is contemplated that the plurality of symbols 106a-c may include a combination of any two of first volumetric symbols 106a, second volumetric symbols 106b, additional volumetric symbols, and planar symbols 106c. Each of the plurality of symbol-bearing reels 104a-e includes a surface 108 defining a geometric plane. The geometric plane can be, for example, a Euclidean plane or a non-Euclidean plane. The volumetric symbols 106a,b have a dimension that extends away from (e.g., orthogonally from) the geometric plane, while the planar symbols 106c lie on the geometric plane. By “lie on” a geometric plane, it is contemplated that one or more of the planar symbols 106c may be parallel to and spaced a distance from the geometric plane. For example, any of the planar symbols 106c may appear to hover above the surface 108 of the symbol-bearing reels 104a-e, but still retain their planar dimensionality.

In some embodiments, the volumetric symbols 106a,b satisfy a predetermined criterion that can be generally correlated with higher player interest in the symbols, while the planar symbols 106c do not satisfy the same predetermined criterion. The predetermined criterion can include, for example, higher expected values of the volumetric symbols 106a,b compared to the expected values of planar symbols 106c, specialized functions of the volumetric symbols 106a,b that are not associated with the planar symbols 106c, etc., and/or combinations thereof. In a non-limiting example involving different expected value of the symbols, generally higher-value symbols within the pay table are displayed as volumetric symbols 106a,b, while generally lower-value symbols within the pay table are displayed as planar symbols 106c. Non-limiting examples involving different symbol functionality includes displaying triggering symbols, wild symbols, payout-multiplier symbols, and/or the like as volumetric symbols 106a,b while displaying line-pay and scatter-pay symbols from the paytable as planar symbols 106c. The former symbol functionalities have an enhanced functionality or value compared to the latter symbol functionalities.

As shown in FIGS. 4-5B, volumetric symbols 106a,b outside of the array 102 are displayed within the field of view of the player, while planar symbols 106c outside of the array 102 are not generally visible or are not completely visible in an undistorted manner to the player. The visibility of volumetric symbols just outside of the array provides the player with more visual indications of “near miss” opportunities involving enhanced symbols and increases player excitement in the wagering game. Further, the selective presentation of only high-player-interest symbols using volumetric symbols 106a,b allows the player to quickly evaluate and appreciate a perceived high-value opportunity that was almost obtained or is about to be obtained. This increase in player excitement and quicker evaluation can further be enhanced by increasing the perceived height of the volumetric symbols.

In some embodiments, for example, the volumetric symbols may be sufficiently tall so as to partially or fully obscure adjacent symbols within the array. Additionally, volumetric symbols of various virtual heights may be utilized, and in some embodiments, the height of the symbol generally corresponds to the perceived value of that symbol. For example, three different volumetric symbols may be utilized, with the tallest volumetric symbol representing a bonus symbol, the middle-height volumetric symbol representing a wild symbol, and the shortest volumetric symbol representing a high-value standard symbol. In this embodiment, all other symbols could be represented as planar symbols. It should be noted that various quantities, heights, and appearances of volumetric symbols may be utilized to create the desired level of enhancement for a particular array or wagering game.

FIG. 4 illustrates an animated representation of spinning and stopping the symbol-bearing reels 104a-e, one at a time. The first symbol-bearing reel 104a has come to a stop while the remaining symbol-bearing reels 104b-e continue spinning as indicated by the arrows showing the direction of movement of the reels 104b-e in the animated simulation. The visible symbols share at least one perspective vanishing point. Thus, during the spinning, a volumetric symbol 106a that is visible just outside of the array 102 (on the “horizon” of the array) is depicted as expanding or growing in size as it draws nearer to the array 102, which is shown at a perspective view angled toward the player. This expansion or enlargement of the symbol occurs as the visible volumetric symbol 106a approaches the array 102. Expansion of the symbol can also include displaying a greater portion of the visible volumetric symbol 106a,b within the field of view of the player. Beneficially, the expansion also conveys to the player a perceived number of symbol positions that the volumetric symbol 106a,b must traverse prior to entering the array 102. In a non-limiting example, the first volumetric symbol 106a is visible for three symbol positions prior to entering the array 102. In this example, when the first volumetric symbol 106a is four or more positions away from the array 102, the first volumetric symbol 106a is not visible to the player. A portion of the first volumetric symbol 106a then enters the field of view of the player and the first volumetric symbol 106a is expanded as it moves from four positions away from the array 102 to three positions away from the array 102. When the first volumetric symbol 106a is three positions from the array 102, only a portion of the first volumetric symbol 106a, such as the top one-third, is visible to the player. The first volumetric symbol 106a is then expanded to simulate movement toward the array 102. When the first volumetric symbol 106a is two symbol positions away from the array 102, a greater portion of the first volumetric symbol 106a, such as the top two-thirds, is visible to the player (but planar symbols 106c in the same positions on adjacent reels 104d,e are not yet visible in the field of view). The first volumetric symbol 106a is then expanded yet further (a larger portion of the first volumetric symbol 106a becomes visible to the player) to continue simulation of movement toward the array 102. When the first volumetric symbol 106a is only one symbol position away from the array 102, a yet greater portion of the first volumetric symbol 106a, such as the entire symbol, becomes visible to the player (though a planar symbol in the same position on reel 104d is still not visible in the field of view). This expansion and perception of distance of the volumetric symbols 106a,b is generally visible to the player during spinning and increases player excitement during the wagering game, especially as the respective symbol-bearing reel 104a-e begins to slow toward a stop. In the meantime, planar symbols 106c in the same positions on adjacent reels 104d,e are not visible as the first volumetric symbol 106a moves along the three positions and more of that symbol 106a becomes visible to the player.

In the illustrated embodiment, the first volumetric symbols 106a extend a first distance D1 away from the geometric plane and the second volumetric symbols 106b extend a second distance D2 away from the geometric plane. The extension from the geometric plane provides the volumetric symbols 106a,b with perceived virtual heights based on the first distance D1 and the second distance D2, whereas the planar symbols 106c appear to have no virtual height or thickness. This results in the different volumetric symbols 106a,b being visible at a different number of symbol positions away from the array 102. In a non-limiting example, the perceived virtual height of the second volumetric symbol 106b is one-third the perceived virtual height of the first volumetric symbol 106a. In this example, the first volumetric symbol 106a is visible for three symbol positions prior to entering the array 102, but the second volumetric symbol 106b is visible for only one symbol position prior to entering the array 102 due to its smaller virtual height. When the second volumetric symbol 106b is two or more positions from the array 102, the second volumetric symbol 106b is not visible to the player. The second volumetric symbol 106b enters the field of view and a portion of the second volumetric symbol 106b becomes visible to the player as the second volumetric symbol 106b moves from two positions away from the array 102 to one position away from the array 102. When the second volumetric symbol 106b is one symbol position away from the array 102, a portion of the second volumetric symbol 106b, such as the entire symbol or a top portion of the symbol, is visible to the player. As can be seen, in an example, the first volumetric symbol 106a positioned three symbol positions away from the array 102 is visible within the field of view of the player, while second volumetric symbols 106b and planar symbols 106c in immediately adjacent symbol positions are not visible within the field of view of the player. Similarly, in an example, a second volumetric symbol 106b is visible within the field of view of the player while planar symbols 106c in adjacent positions outside of the array 102 are not visible within the field of view of the player.

The different virtual heights of the symbols can be selected based on an associated general level of player interest in the symbols relative to each other. In a non-limiting example, the volumetric symbols 106a,b satisfy a single predetermined criterion based on the respective pay-table value. For example, if the value of the first volumetric symbol 106a is three times the value of the second volumetric symbol 106b, the first distance D1 can be three times the second distance D2. This also allows for selective presentation of high-player-interest symbols by reducing the number of volumetric symbols 106a,b visible to the player at certain distances. This can also be used to increase player anticipation of higher-value volumetric symbols 106a,b relative to lower-value volumetric symbols 106a,b. Generally speaking, the relative value of a given volumetric symbol 106a can be commensurate with or proportional to its virtual height-distance relative to other volumetric symbols. Further, the different heights of symbols may cause a different number of adjacent symbols to be obscured by a particular volumetric symbol.

In some embodiments, visual effects related to the volumetric symbols 106a,b are simulated to increase player excitement during spinning of the reels by making the volumetric symbols 106a,b more easily visually perceptible than the planar symbols 106c. For example, the volumetric symbols 106a,b cast shadows on the reels whereas the planar symbols In some embodiments, visual effects are used to also make certain volumetric symbols 106a,b more easily perceptible than certain other volumetric symbols 106a,b. For example, in the illustrated embodiment, the second volumetric symbol 106b includes a multi-faceted appearance. During the spinning, lighting is simulated using, for example a graphics processing unit. Each face of the second volumetric symbol 106b reflects the simulated lighting such that the second volumetric symbol 106b gleams during movement of the reels. The gleaming is generally perceptible to the player while the second volumetric symbol 106b is within the field of view of the player. These visual effects can be used, for example, to increase player excitement during spinning of the symbol-bearing reels 104a-e.

FIG. 5A illustrates a game outcome displayed after the animated representation of spinning the symbol-bearing reels 104a-e has stopped and a game outcome is displayed, according to some aspects of the present disclosure. In some embodiments, use of volumetric symbols 106a,b can obscure the player's view of a portion of adjacent symbols. This obfuscation can be alleviated by controlled alteration of the volumetric symbols 106a,b prior to or during a displayed evaluation of the game outcome. For example, obfuscation caused by an unaltered volumetric symbol 106a,b can be alleviated by altering the volumetric symbol 106a,b to reveal the obscured symbols. This alteration can include temporarily shrinking the volumetric symbol 106a,b, making the volumetric symbol 106a,b planar (e.g., by appearing to “flatten” or “squash” the symbol 106a,b), making parts or all of the volumetric symbol 106a,b translucent or transparent, or moving the volumetric symbol 106a,b.

In another example, obfuscation caused by an altered volumetric symbol 106a,b can be alleviated by controlling the timing of the alteration. In the illustrated embodiment, the first volumetric symbol 106a has been altered from a closed treasure chest symbol during the spinning of the reels 104, to an open treasure chest symbol following stoppage of the reels 104. For example, this opening of the treasure chest symbol could block the player's view of portions or the entirety of a symbol located immediately behind the treasure chest symbol. In some aspects, the treasure chest symbols are evaluated last (in a temporal sense) and are not opened until evaluation. In other aspects, the treasure chest symbols are open only during evaluation of the treasure chest symbols and remain closed at all other times.

FIG. 5B illustrates the game outcome displayed after the animated representation of spinning the symbol-bearing reels 104a-e has stopped and a game outcome is displayed within the array 102, according to some aspects of the present disclosure. Obfuscation of adjacent symbols by the volumetric symbols 106a,b can be alleviated by, additionally or alternatively, transitioning the view of the plurality of the symbol-bearing reels 104a-e. This transition can be, for example, from the perspective view shown during spinning to a second perspective view or a plan view during display and evaluation of the game outcome. In the illustrated example, the plurality of symbol-bearing reels 104a-e has been transitioned to a second perspective view by effectively “tilting” the field of view closer to the player so that the most distally located symbols (relative to the player) now appear closer to the player. For example, this transition also allows the player to better view near-miss opportunities presented by volumetric symbols 106a,b that stopped prior to entering the array 102.

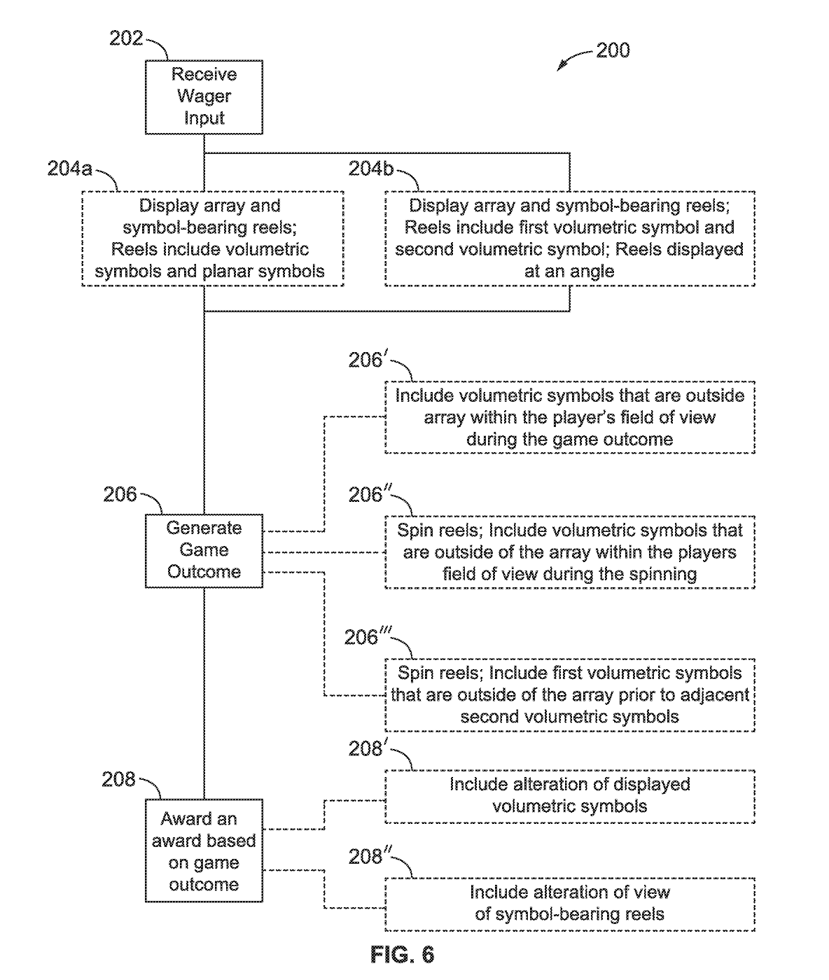

FIG. 6, described by way of example, represents one algorithm that corresponds to at least some instructions stored and executed by the game-logic circuitry 28 in FIG. 2 to perform the above described functions associated with the disclosed concepts. The exemplary algorithm 200 includes receiving a wager, at block 202, from a player to initiate a wagering game. The wager is placed or otherwise confirmed, for example, using a bill validator 22, coin acceptor, information reader 24, or other input device. After receiving the wager, an array and a graphical representation of a plurality of symbol-bearing reels are displayed, at block 204a or 204b, within a field of view of the player on at least one of one or more display devices. The array 102 includes at least a portion of the symbol-bearing reels therein. At block 204a, the plurality of symbol-bearing reels include a plurality of volumetric symbols 106a,b and a plurality of planar symbols 106c, as described above. Alternatively to block 204a, in block 204b, the array 102 includes a plurality of first volumetric symbols 106a and a plurality of second volumetric symbols 106b, also as described above. In some embodiments, the symbol-bearing reels are displayed at a perspective view to the player.

At block 206, a game outcome is generated responsive to receiving the input indicative of the wager. The generated outcome includes an animated representation of spinning the symbol-bearing reels 104a-e. In some embodiments, during the spinning, the volumetric symbols 106a,b are visible to the player prior to entering the array 102, at block 206′. In some embodiments, the volumetric symbols 106a,b that are near the array 102 are visible to the player, at block 206″. In some embodiments, during the spinning, first volumetric symbols 106a are visible to the player prior to second volumetric symbols 106b and/or planar symbols 106c in adjacent positions, at block 206′″.

At block 208, an award is awarded to the player. The award is based on symbols disposed within the array 102. In some embodiments, the displayed volumetric symbols 106a,b are altered as described above, at block 208′. In some embodiments, the view of the symbol-bearing reels 104a-e is altered as described above (208″).

In some embodiments, the first volumetric symbols 106a and the second volumetric symbols 106b extend the same distance from the geometric plane.

Additionally or alternatively, in some embodiments, the volumetric symbols 106a,b are visible after traversing and exiting the array 102. In one non-limiting example, the first volumetric symbol 106a is visible for three symbol positions after exiting the array 102 and the second volumetric symbol 106b is visible for one symbol position after exiting the array 102. This visibility contributes to player excitement similarly to the above-described examples.

In some aspects, a gaming system comprises one or more input devices, one or more display devices, and game-logic circuitry. The game-logic circuitry comprises one or more central processing units and one or more memory devices. The one or more memory devices store instructions that, when executed by the one or more central processing units, cause the game-logic circuitry to receive an input indicative of a wager, display an array and a graphical representation of a plurality of symbol-bearing reels within a field of view a player, and award an based on a generated game outcome. The input indicative of a wager is received via at least one of the one or more input devices. The array and the graphical representation of the plurality of symbol-bearing reels is displayed on at least one of the one or more display devices. The array includes at least a portion of the symbol-bearing reels. The plurality of symbol-bearing reels includes a plurality of first symbols and a plurality of second symbols. Each of the symbol-bearing reels includes a surface defining a geometric plane. The symbols in the plurality of first symbols are volumetric symbols extending a distance away from the surface. The symbols in the plurality of second symbols are planar symbols lying on the geometric plane. The award based on the generated outcome is awarded using the game-logic circuitry and is responsive to receiving the input indicative of the wager. The award is determined based on symbols disposed within the array for the generated game outcome. The generated game outcome also includes an animated representation of spinning the symbol-bearing reels. During the spinning, at least one of the first symbols is visible within the field of view prior to entering the array.

In some aspects, the graphical representation of the plurality of symbol-bearing reels includes the plurality of symbol-bearing reels being oriented at a perspective view relative to the player. In further aspects, the instructions also cause the game-logic circuitry to transition, after the spinning, the graphical representation of the plurality of the symbol-bearing reels from the perspective view to a second perspective view or a plan view.

In some aspects, the animated representation of spinning the symbol-bearing reels includes expanding the at least one visible first symbol to cause the at least one visible symbol to approach the array.

In some aspects, symbols included within the plurality of first symbols satisfy a predetermined criterion. In further aspects, the predetermined criterion includes at least one of an expected value of a respective symbol or a symbol functionality.

In some aspects, the volumetric symbols include a first volumetric symbol and a second volumetric symbol. The first volumetric symbol extends a first distance away from the surface. The second volumetric symbol extends a second distance away from the surface. The second distance is shorter than the first distance.

In some aspects, a computer-implemented method in a gaming system includes receiving an input indicative of a wager, displaying an array and a graphical representation of a plurality of symbol-bearing reels within a field of view of a player, generating a game outcome, and awarding an award. The gaming system has game-logic circuitry including one or more central processing units and one or more memory devices. The input indicative of a wager is received via at least one of one or more input devices. The array and the graphical representation of the plurality of symbol-bearing reels are displayed on at least one of one or more display devices. The array includes at least a portion of the symbol-bearing reels. The graphical representation of the symbol-bearing reels is oriented at a perspective view relative to the player. The plurality of symbol-bearing reels includes a plurality of first symbols and a plurality of second symbols. Each of the symbol-bearing reels includes a surface defining a geometric plane. The plurality of first symbols includes first volumetric symbols extending a first distance away from the surface. The plurality of second symbols includes second volumetric symbols extending a second distance away from the surface, with the second distance being shorter than the first distance. The game outcome is generated using the game-logic circuitry and is responsive to receiving the input indicative of the wager. Generating the game outcome includes an animated representation of spinning the symbol-bearing reels. During the spinning, at least one of the first volumetric symbols is visible within the field of view prior to an adjacent one of the second volumetric symbols becoming visible within the field of view. The award is awarded using the game-logic circuitry and is based on symbols disposed within the array for the generated game outcome.

In some aspects, the plurality of first symbols and the plurality of second symbols satisfy a predetermined criterion. In some further aspects, the predetermined criterion is at least one of an expected value of a respective symbol or a symbol functionality. In some yet further aspects, the predetermined criterion is an expected value of a respective symbol, and the first distance and the second distance are indicative of the expected values of the first volumetric symbols relative to the second volumetric symbols.

In some aspects, at least one of the first volumetric symbols and the second volumetric symbols is visible within the field of view after leaving the array.

In some aspects, the symbol-bearing reels further include a plurality of third symbols. The third symbols are planar symbols lying on the geometric plane.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system, comprising:
a gaming machine primarily dedicated to playing at least one casino wagering game, the gaming machine including a gaming cabinet, an electronic display device, and an electronic input device, the cabinet constructed to house components associated with the casino wagering game, the electronic display device and the electronic input device being coupled to the gaming cabinet, the electronic input device configured to receive a physical input from a player to initiate the casino wagering game and transform the input into an electronic data signal;
a random element generator configured to generate one or more random elements; and
game-logic circuitry configured to:
initiate the casino wagering game in response to the electronic data signal from the electronic input device of the gaming machine,
display, on the electronic display device, a graphical representation of a plurality of symbol-bearing reels and an array within a field of view of a player, each of the symbol-bearing reels including a surface defining a geometric plane, the plurality of symbol-bearing reels including a plurality of planar symbols and a plurality of first volumetric symbols, each of the plurality of planar symbols and each of the plurality of first volumetric symbols being disposed at a respective position on the symbol-bearing reels, the plurality of planar symbols lying on the geometric plane, the plurality of first volumetric symbols having a first virtual height extending a first distance away from the surface such that the first volumetric symbols obscure a view of at least a first portion an adjacent planar symbol, the first volumetric symbols satisfying a predetermined criterion that is not satisfied by the planar symbols;
determine an outcome of the casino wagering game based, at least in part, on the one or more random elements;
direct the electronic display device of the gaming machine to display the outcome using the graphical representation of the plurality of symbol-bearing reels; and
award an award in response to the outcome meeting a predetermined award criterion, the predetermined award criterion including evaluation of symbols on the symbol-bearing reels that are disposed within the array.

2. The gaming system of claim 1, wherein the plurality of symbol-bearing reels further includes a plurality of second volumetric symbols, each of the plurality of second volumetric symbols disposed at a respective position on the symbol-bearing reels, the second volumetric symbols having a second virtual height, the second virtual height extending a second distance away from the surface such that the second volumetric symbols obscure a view of at least a second portion of an adjacent planar symbol, the second distance being less than the first distance such that the first portion is greater than the second portion, and wherein the second volumetric symbols satisfy a second predetermined criterion that is not satisfied by the planar symbols.

3. The gaming system of claim 1, wherein the graphical representation of the plurality of symbol-bearing reels includes the plurality of symbol-bearing reels being oriented at a perspective view relative to the player, and wherein the game-logic circuitry is further configured to transition the graphical representation of the plurality of symbol-bearing reels such that the first portion of the adjacent planar symbol is revealed to the player.

4. The gaming system of claim 1, wherein the game-logic circuitry is further configured to transition display of the first volumetric symbol such that the first portion of the adjacent planar symbol is revealed to the player.

5. The gaming system of claim 1, wherein the predetermined criterion is at least one of a symbol functionality or an expected value of a respective symbol.

6. The gaming system of claim 1, wherein the random element generator and the game-logic circuitry reside within the gaming cabinet.

7. The gaming system of claim 1, wherein the gaming machine includes a value input device disposed on the gaming cabinet and used to fund the casino wagering game.

8. A method of operating a gaming system, the gaming system including a random element generator, game-logic circuitry, and a gaming machine, the gaming machine primarily dedicated to playing at least one casino wagering game, the gaming machine including a gaming cabinet, an electronic display device, and an electronic input device, the cabinet constructed to house components associated with the casino wagering game, the electronic display device and the electronic input device being coupled to the gaming cabinet, the method comprising:
generating one or more random elements with the random element generator;
receiving, responsive to a physical input to the electronic input device of the gaming machine, a wager input to initiate the casino wagering game;
displaying, on the electronic display device, a graphical representation of a plurality of symbol-bearing reels and an array within a field of view of a player, each of the symbol-bearing reels including a surface defining a geometric plane, the plurality of symbol-bearing reels including a plurality of planar symbols and a plurality of first volumetric symbols, each of the plurality of planar symbols and each of the plurality of first volumetric symbols being disposed at a respective position on the symbol-bearing reels, the plurality of planar symbols lying on the geometric plane, the plurality of first volumetric symbols having a first virtual height extending a first distance away from the surface such that the first volumetric symbols obscure a view of at least a first portion an adjacent planar symbol, the first volumetric symbols satisfying a predetermined criterion that is not satisfied by the planar symbols;
determining, by the game-logic circuitry, an outcome of the casino wagering game based, at least in part, on the one or more random elements;
displaying the outcome on the electronic display device of the gaming machine using the graphical representation of the plurality of symbol-bearing reels; and
awarding, by the game-logic circuitry, an award in response to the outcome meeting a predetermined award criterion, the predetermined award criterion including evaluation of symbols on the symbol-bearing reels that are disposed within the array.

9. The method of operating a gaming system of claim 8, wherein the plurality of symbol-bearing reels further includes a plurality of second volumetric symbols, each of the plurality of second volumetric symbols disposed at a respective position on the symbol-bearing reels, the second volumetric symbols having a second virtual height extending a second distance away from the surface such that the second volumetric symbols obscure at least a second portion of an adjacent planar symbol, the second distance being less than the first distance such that the first portion is greater than the second portion, and wherein the second volumetric symbols satisfy a second predetermined criterion that is not satisfied by the planar symbols.

10. The method of operating a gaming system of claim 8, wherein the graphical representation of the plurality of symbol-bearing reels includes the plurality of symbol-bearing reels being oriented at a perspective view relative to the player.

11. The method of operating a gaming system of claim 8, further comprising transitioning the graphical representation of the plurality of symbol-bearing reels to reveal the first portion of the adjacent planar symbol.

12. The method of operating a gaming system of claim 8, further comprising transitioning display of the first volumetric symbol such that the first portion of the adjacent planar symbol is revealed to the player.

13. The method of operating a gaming system of claim 8, wherein the predetermined criterion is at least one of a symbol functionality or an expected value of a respective symbol.

14. The method of operating a gaming system claim 8, wherein the first volumetric symbols obscure the view of the entire adjacent planar symbol.

15. The method of operating a gaming system of claim 8, further comprising:
spinning, using an animated representation, the symbol-bearing reels prior to displaying the outcome,
wherein the view of the adjacent planar symbol is obscured by the first volumetric symbols during the spinning.

16. The method of operating a gaming system of claim 15, wherein, during the spinning, the first volumetric symbols are visible within the field of view prior to entering the array and prior to an adjacent planar symbol being visible.

17. A gaming system, comprising:
a gaming machine primarily dedicated to playing at least one casino wagering game, the gaming machine including a gaming cabinet, an electronic display device, and an electronic input device, the cabinet constructed to house components associated with the casino wagering game, the electronic display device and the electronic input device being coupled to the gaming cabinet, the electronic input device configured to receive a physical input from a player to initiate the casino wagering game and transform the input into an electronic data signal;
a random element generator configured to generate one or more random elements; and
game-logic circuitry configured to:
initiate the casino wagering game in response to the electronic data signal from the electronic input device of the gaming machine,
display, on the electronic display device, a graphical representation of a plurality of symbol-bearing reels and an array within a field of view of a player, each of the symbol-bearing reels including a surface defining a geometric plane, the plurality of symbol-bearing reels including a plurality of first symbols and a plurality of second symbols, each of the plurality of first symbols and each of the plurality of second symbols being disposed at a respective position on the symbol-bearing reels, each of the symbol-bearing reels including a surface defining a geometric plane, the plurality of first symbols being volumetric symbols extending a distance away from the surface, the plurality of second symbols being planar symbols lying on the geometric plane;
determine an outcome of the casino wagering game based, at least in part, on the one or more random elements;
direct the electronic display device of the gaming machine to display the outcome using the graphical representation of the plurality of symbol-bearing reels, the display of the outcome including an animated representation of spinning the symbol-bearing reels, at least one of the first symbols being visible within the field of view prior to entering the array while the respective position of the at least one first symbol on the symbol-bearing reel is not visible within the field of view; and
award an award in response to the outcome meeting a predetermined award criterion, the predetermined award criterion including evaluation of symbols on the symbol-bearing reels that are disposed within the array.

18. The gaming system of claim 17, wherein the graphical representation of the plurality of symbol-bearing reels includes the plurality of symbol-bearing reels being oriented at a perspective view relative to the player, and wherein game-logic circuitry is further configured to transition, after the animated representation of spinning the symbol-bearing reels, the graphical representation of the plurality of the symbol-bearing reels from the perspective view to a second perspective view or a plan view.

19. The gaming system of claim 17, wherein at least one of the first symbols is visible within the field of view after leaving the array.

20. The gaming system of claim 17, wherein the volumetric symbols include first volumetric symbols and second volumetric symbols, the first volumetric symbols extending a first distance away from the surface, the second volumetric symbols extending a second distance away from the surface, the second distance being shorter than the first distance.
